(19) United States
(12) Patent Application Publication
(10) Pub. No.: US 2016/0010716 A1
(43) Pub. Date: Jan. 14, 2016

(54) SHOCK ABSORBER

(71) Applicants: TOYOTA JIDOSHA KABUSHIKI KAISHA, Aichi (JP); AISIN SEIKI KABUSHIKI KAISHA, Aichi (JP); HITACHI AUTOMOTIVE SYSTEMS, LTD., Ibaraki (JP)

(72) Inventors: Tatsuya KEIDA, Nagoya-shi (JP); Ikuhide IYODA, Nissin-shi (JP); Masaaki TABATA, Nagoya-shi (JP); Takashi KUROKOUCHI, Toyota-shi (JP); Kazunori KONDO, Kariya-shi (JP); Umi TANABE, Kawasaki-shi (JP)

(21) Appl. No.: 14/791,810

(22) Filed: Jul. 6, 2015

(30) Foreign Application Priority Data
Jul. 11, 2014 (JP) 143594/2014

(51) Int. Cl. F16F 9/38; F16F 9/32; F16F 9/44

(52) U.S. Cl. CPC F16F 9/38; F16F 9/446; F16F 9/3207

(57) ABSTRACT

A foreign object discharge hole is provided at a position that is located on a lowermost side of the cover when a shock absorber is in a mounted state, and a size of the foreign object discharge hole is set to be similar to or larger than a size of a space between an outlet port and a harness. This can ensure that a foreign object introduced into the cover is discharged out of the cover via the foreign object discharge hole.

### TECHNICAL FIELD

The present invention relates to a shock absorber including a damping force adjustment mechanism.

There is known a damping force adjustable shock absorber configured to cover a harness connected to a damping force adjustment mechanism with a cover including a port for taking out the harness therefrom. Such a damping force adjustable shock absorber raises a possibility that a water removal hole of the cover may be closed by a foreign object introduced into the cover via a space between the harness and the port for taking out the harness therefrom.

Japanese Patent Application Public Disclosure No. S62-60736 discusses one example of such a configuration.

### SUMMARY OF INVENTION

Therefore, the present invention has been contrived in consideration of the above-described circumstance, and is directed to providing a shock absorber that can ensure a discharge of the foreign object introduced into the cover via the space between the harness and the port for taking out the harness therefrom.

According to an aspect of the present invention, a damping force adjustable shock absorber, which is configured to be mounted between relatively movable two members, includes a cylinder sealingly containing hydraulic fluid, a piston disposed or inserted in the cylinder, a piston rod coupled to the piston and extending out of the cylinder, a damping force adjustment mechanism disposed in a housing protruding from a side of the cylinder, and a cover at least partially covering an outer peripheral portion of the housing. The damping force adjustment mechanism includes a solenoid, and a harness for supplying power to the solenoid from outside. The cover includes an outlet port for taking out the harness, and a foreign object discharge hole provided at a position that is located on a lower side when the shock absorber is in a mounted state. A size of the foreign object discharge hole is similar to or larger than a size of a space between the outlet port and the harness.

According to the present invention, it is possible to ensure the discharge of the foreign object introduced into the cover via the space between the harness and the port for taking out the harness therefrom.

### BRIEF DESCRIPTION OF DRAWINGS

FIG. 1 is a cross-sectional view illustrating a shock absorber according to an embodiment of the present invention that is taken along an axial plane, and in particular, indicates a damping force adjustment mechanism by a virtual line.

FIG. 2 is a cross-sectional view taken along a line A-A illustrated in FIG. 1, and in particular, illustrates an outer tube, a housing, a cover, and an attachment bracket.

FIG. 3 illustrates the present embodiment, and is an exploded perspective view illustrating the cover and the outer tube with the attachment bracket joined thereto.

FIG. 4 is an enlarged view illustrating main parts of the shock absorber according to the present embodiment.

FIG. 5 illustrates the present embodiment, and in particular, illustrates the shock absorber when the cover maximally approaches an upper surface of a curbstone while the shock absorber is mounted on a vehicle.

### DESCRIPTION OF EMBODIMENTS

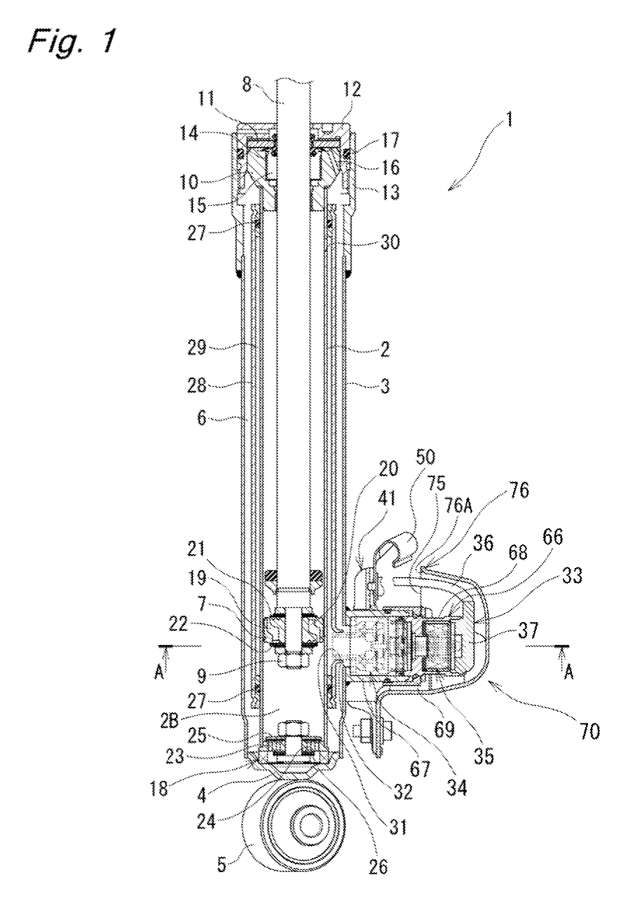

One embodiment of the present invention will be described with reference to the accompanying drawings. The present embodiment will be described as, by way of example, a damping force adjustable shock absorber 1 (hereinafter referred to as a “shock absorber 1”) including a control valve attached alongside thereto that is used for a semi-active suspension apparatus of a vehicle. In the following description, a vertical direction in FIG. 1 will be defined as a vertical direction (a direction along an axis) of the shock absorber 1 for convenience of the description.

As illustrated in FIG. 1, the shock absorber 1 has a twin-tube structure including an inner tube 2 (a cylinder), and an outer tube 3 disposed outside the inner tube 2. The outer tube 3 is closed by a bottom cap 4 joined to a lower end of the outer tube 3. A mounting eye 5 is provided at the bottom cap 4. The mounting eye 5 is attached to a vehicle wheel-side member (for example, a knuckle) of the vehicle. An annular reservoir 6 is formed between the inner tube 2 and the outer tube 3. A piston 7 is slidably fitted to an inner surface of the inner tube 2. The inside of the inner tube 2 is vertically divided into a first chamber 2A and a second chamber 2B by the piston 7.

One end of a piston rod 8 is coupled to the piston 7 by a nut 9. An opposite end side (an upper side in FIG. 1) of the piston rod 8 is inserted through a rod guide 10, a seal member 11, and a cap 12 via the first chamber 2A, and extends out of the inner tube 2. The rod guide 10 is fitted to an upper end of the inner tube 2. The cap 12 is threadably engaged with a generally cylindrical casing 13 joined to an upper end of the outer tube 3. The seal member 11 is formed by baking an elastic member onto a metallic disk, and an outer circumferential portion of the seal member 11 is sandwiched by the rod guide 10 and the cap 12. Further, a lip seal 14 is provided on a lower surface side of the seal member 11. The lip seal 14 is in abutment with the rod guide 10. The lip seal 14 allows oil as hydraulic fluid to flow from a chamber 15 into the reservoir 6 via a return passage 16, but prohibits the oil from flowing in a reverse direction. An O-ring 17 provides a seal between the cap 12 and the casing 13.

A base valve 18 is provided on a lower end of the inner tube 2. The base valve 18 separates the second chamber 28 and the reservoir 6. Passages 19 and 20 are formed through the piston 7. The passages 19 and 20 establish communication between the first chamber 2A and the second chamber 2B. A check valve 21 is provided in the passage 20. The check valve 21 allows only the hydraulic fluid to flow from the second chamber 2B side to the first chamber 2A side. A disk valve 22 is provided in the passage 19. The disk valve 22 opens when a pressure of the hydraulic fluid reaches a predetermined pressure on the first chamber 2A side, and releases the pressure of the hydraulic fluid from this first chamber 2A side to the second chamber 2B side.

Passages 23 and 24 are formed through the base valve 18. The passages 23 and 24 establish communication between the second chamber 2B and the reservoir 6. A check valve 25 is provided in the passage 23. The check valve 25 allows only the hydraulic fluid to flow from the reservoir 6 side to the second chamber 2B side. A disk valve 26 is provided in the passage 24. The disk valve 26 opens when the pressure of the hydraulic fluid reaches a predetermined pressure on the second chamber 2B side, and releases the pressure of the hydraulic fluid from this second chamber 2B side to the reservoir 6 side. The oil as the hydraulic fluid is sealingly contained in the inner tube 2, and the oil and gas are sealingly contained in the reservoir 6.

Both ends of a separator tube 28 are fitted to outer peripheral portions of the both ends of the inner tube 2 via seal members 27. An annular flow passage 29 is formed between the inner tube 2 and the separator tube 28. The annular flow passage 29 is in communication with the first chamber 2A via a passage 30 formed through a sidewall of the inner tube 2 in the vicinity of the upper end of the inner tube 2. A branch tube 31, which is shaped by burring, is provided on a sidewall of the separator tube 28. The branch tube 31 protrudes from a lower portion of the sidewall of the separator tube 28 in a radial direction of the separator tube 28 (a rightward direction in FIG. 1).

A housing 66 is provided on a sidewall of the outer tube 3. The housing 66 contains a damping force adjustment mechanism 33, which will be described below. The housing 66 includes a generally cylindrical first housing 67, which contains a damping force adjustment valve 34. The first housing 67 extends from a lower portion of the outer tube 3 toward a radially outer side of the outer tube 3 (in the rightward direction in FIG. 1), and a proximal end of the first housing 67 (a left-side end in FIG. 1) is joined to around a connection port 32 formed through the sidewall of the outer tube 3. The housing 66 further includes a generally cylindrical second housing 68. The second housing 68 is connected to a distal end of the first housing 67 (a right-side end in FIG. 1). The second housing 68 contains a solenoid 35 of the damping force adjustment mechanism 33. Further, the housing 66 includes a lock nut 69 for fastening the first housing 67 and the second housing 68 to each other.

The above-described damping force adjustment mechanism 33 includes the damping force adjustment valve 34 (a damping force generation unit) disposed on an inner tube 2 side (a left side in FIG. 1, hereinafter referred to as a “cylinder side”), the solenoid 35 disposed on a spaced-apart side from the inner tube 2 (the cylinder) (a right side in FIG. 1, hereinafter referred to as a “spaced-apart side from the cylinder”), a harness 36 that supplies power from a control unit (outside) to the solenoid 35, and a connector 37 provided at an end of the harness 36 on a solenoid 35 side. A conventional configuration can be used for the damping force adjustment mechanism 33 as necessary. Therefore, in the present disclosure, the damping force adjustment mechanism 33 is indicated by a vertical line, and will not be described in detail.

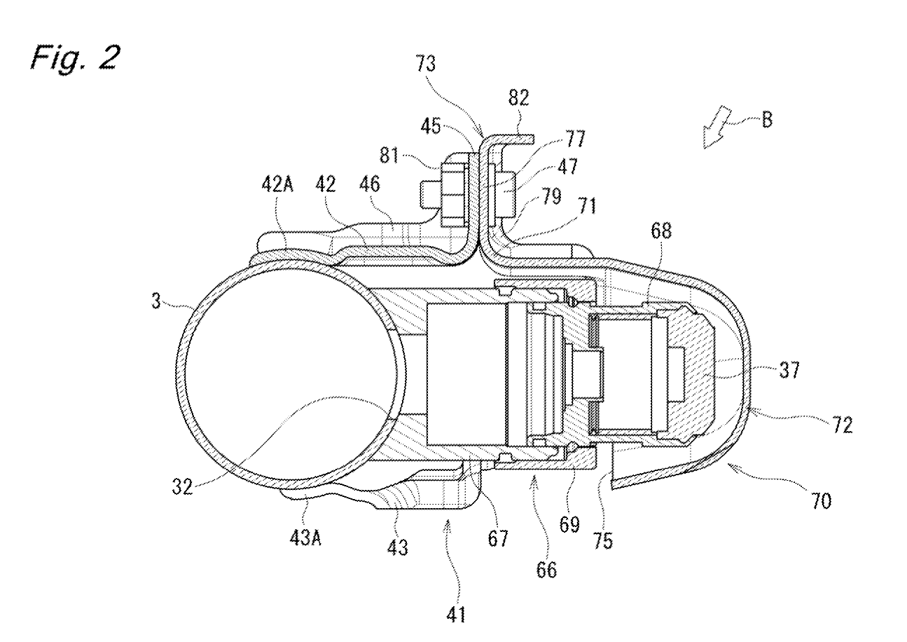

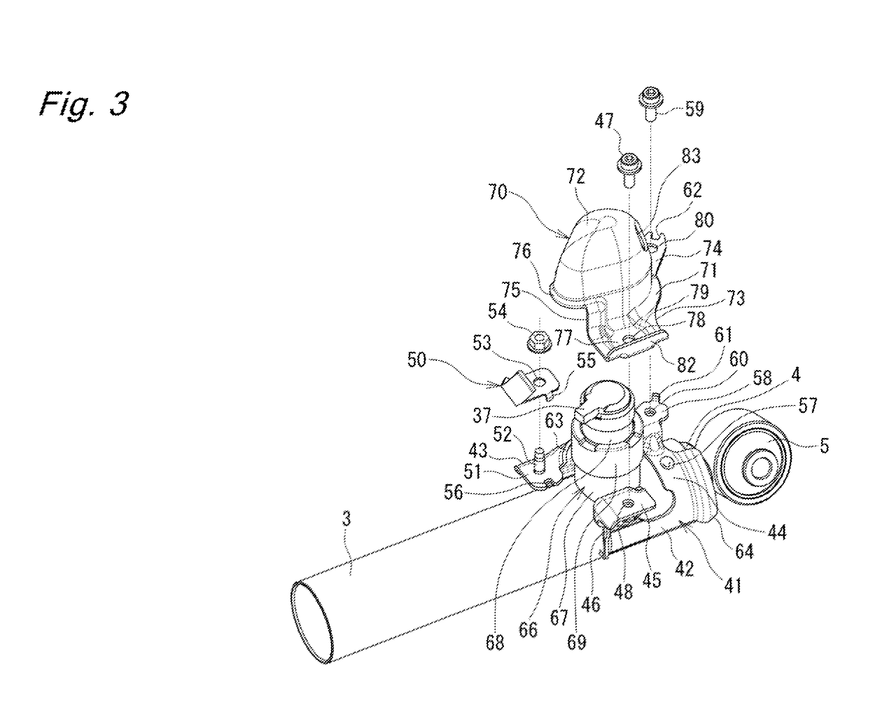

Next, a cover 70 for protecting the damping force adjustment mechanism 33 will be described. The cover 70 is attached to an attachment bracket 41 (an attachment member) provided on the sidewall of the outer tube 3 (the cylinder). The attachment bracket 41 and the cover 70 are each a metallic part formed by press molding. A plate thickness of the attachment bracket 41 is set to be larger than a plate thickness of the cover 70. The attachment bracket 41 has a partially cutout cylindrical shape as illustrated in FIG. 3. The attachment bracket 41 partially extends around the first housing 67 to at least partially cover the first housing 67. Further, the attachment bracket 41 includes a first fixation piece 42, a second fixation piece 43, and a third fixation piece 44 connecting the first fixation piece 42 and the second fixation piece 43 to each other. The first fixation piece 42 and the second fixation piece 43 are disposed on opposite sides of the first housing 67 in a radial direction of the outer tube 3 that intersects with a direction in which the housing 66 protrudes (both sides in a vertical direction in FIG. 2).

As illustrated in FIG. 2, the first fixation piece 42 has an end 42A on one side thereof (a left side in FIG. 2), and this end 42A is joined (welded) to the sidewall of the outer tube 3. A first attachment piece 45 is provided at an end of the first fixation piece 42 on a spaced-apart side from the attachment eye 5 (a left side in FIG. 3). The first attachment piece 45 is used to fasten a flange portion 73 of the cover 70, which will be described below, to the first fixation piece 42. Further, a rib 46 is provided at the first fixation piece 42. The rib 46 serves to improve a stiffness of the first attachment piece 45, and thus strength of attaching the flange portion 73 fastened to the first attachment piece 45. A bolt insertion hole 48 is formed through the first attachment piece 45. The bolt insertion hole 4n allows insertion of a bolt 47, which is used to fasten the flange portion 73 to the first fixation piece 42.

As illustrated in FIG. 2, the second fixation piece 43 has an end 43A on one side (the left side in FIG. 2), and this end 43A is joined (welded) to the sidewall of the outer tube 3. A second attachment piece 51 is provided at an end of the second fixation piece 43 on the spaced-apart side from the attachment eye 5 (the left side in FIG. 3). A harness clamp 50 is attached to the second attachment piece 51. The harness clamp 50 is used to clamp the harness 36 extending from the connector 37 (refer to FIG. 1) to the second attachment piece 51. A stud bolt 52 is erected at a generally central portion of the second attachment piece 51. The stud bolt 52 is inserted through a bolt insertion hole 53 formed through the harness clamp 50. The harness clamp 50 is fixed to the second attachment piece 51 by tightening a nut 54 threadably engaged with the stud bolt 52. Further, a protrusion 55 provided at the harness clamp 50 is engaged with a cutout 56 of the second attachment piece 51, which forms a mechanism for prohibiting the harness clamp 50 from rotating. This rotation prohibition mechanism prohibits the harness clamp 50 from rotating about the stud bolt 52 relative to the second attachment piece 51.

The third fixation piece 44 is joined to the sidewall of the outer tube 3 by at least one welded portion 57. A third attachment piece 58 is provided at an end of the third fixation piece 44 on the second fixation piece 43 side (an upper side in FIG. 3). An arm portion 74 of the cover 70, which will be described below, is fastened to the third attachment piece 58. Further, a bolt insertion hole 60 is formed through the third attachment piece 58. The bolt insertion hole 60 allows insertion of a bolt 59, which is used to fasten the arm portion 74 to the third attachment piece 58. A protrusion 61 provided at the third attachment piece 58 is engaged with a cutout 62 of the arm portion 74, which forms a mechanism for prohibiting the arm portion 74, and thus the cover 70 from rotating. This rotation prohibition mechanism prohibits the cover 70 from rotating about the bolt 59 relative to the attachment bracket 41. Reference numeral 63 indicated in FIG. 3 denotes a burring portion, and reference numeral 64 denotes an enlarged diameter portion, both of which contribute to improvement of a stiffness of the attachment bracket 41.

As illustrated in FIG. 1, the cover 70 has a generally cup-like (bottomed cylindrical) shape including an opening portion 71 and a bottom portion 72, and is configured to partially cover an outer peripheral portion of the housing 66. The cover 70 according to the present embodiment covers a part of an outer peripheral portion of the seal case of the lock nut 69, and an outer peripheral portion of a portion of the second housing 68 that protrudes from the lock nut 69. Further, the cover 70 covers the connector 37 attached to a distal end of the second housing 68, and a part (a base portion) of the harness 36 extending from this connector 37. The cover 70 includes the above-described flange portion 73, and the above-described arm portion 74. The flange portion 73 is formed integrally with the cover 70, and is fastened to the first attachment piece 45 of the attachment bracket 41. The arm portion 74 is also formed integrally with the cover 70, and is fastened to the third attachment piece 58 of the attachment bracket 41.

The expression “partially cover the outer peripheral portion of the housing 66” is used herein as the same meaning as “cover the outer peripheral portion of the housing 66 so as to be able to protect the housing 66 from a damage expectable to be incurred while the vehicle is running normally”. For example, in a case where this shock absorber 1 is mounted on a right rear wheel of the vehicle, this expression means at least partially covering the housing 66 with the cover 70 in such a manner that a stone, which has been laid on a road and has been kicked up by a right front wheel, is prevented from hitting the housing 66 to damage the damping force adjustment mechanism 33.

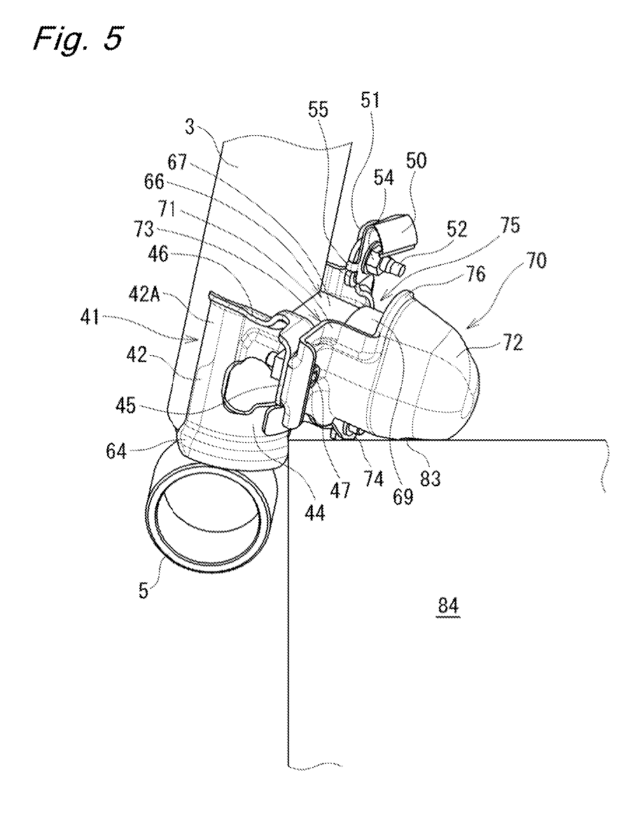

An outlet port 75 is formed at the cover 70. The outlet port 75 is used to take out the harness 36 extending from the solenoid 35. In the present embodiment, the outlet port 75 is provided at a position that is located on an upper side in such a state that the shock absorber 1 illustrated in FIG. 5 is mounted on the vehicle (hereinafter referred to as a “mounted state”). A folded-back portion 76 is provided at the outlet port 75. The folded-back portion 76 is formed by folding back a part of a circumferential edge (the opening portion 71) outwardly from the cover 70 (formed by R-bending). This allows the harness 36 extending from the connector 37 to contact the cover 70 at an R portion 76A of the folded-back portion 76.

The flange portion 73 includes a seat portion 77 that receives the bolt 47, and is brought into abutment with (fastened to) the first attachment piece 45 of the attachment bracket 41. A bolt insertion hole 78 is formed through a center of the seat portion 77. The bolt insertion hole 78 allows insertion of the above-described bolt 47. Further, a sidewall 79 is formed around the seat portion 77. The sidewall 79 serves to improve a stiffness of the flange portion 73. In other words, the flange portion 73 includes the seat portion 77 formed at a recessed bottom of the flange portion 73. The arm portion 74 extends toward a generally opposite side from the flange portion 73 in such a manner that the flange portion 73 and the arm portion 74 extend over the outer tube 3 radially (vertically in FIG. 2). A bolt insertion hole 80 is formed through the arm portion 74. The bolt insertion hole 80 allows insertion of the above-described bolt 59.

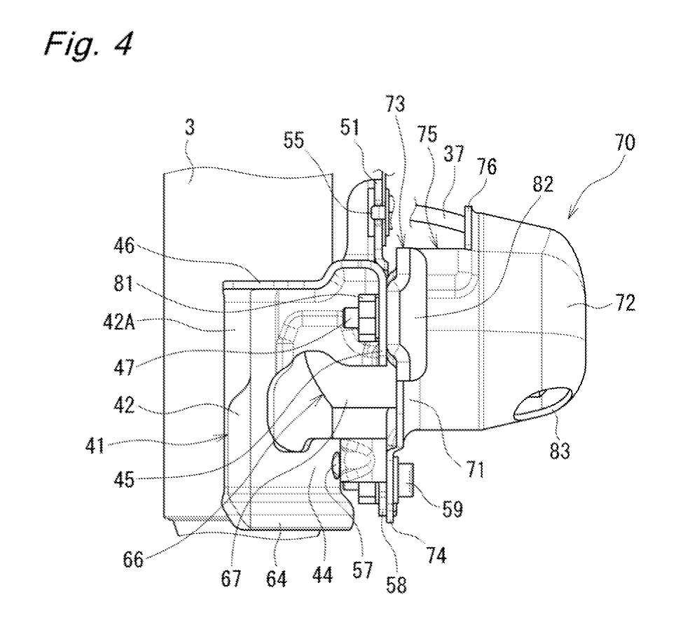

As illustrated in FIG. 2, the flange portion 73 is fastened to the first attachment piece 45 of the attachment bracket 41 by the above-described bolt 47 (a fastening member) and a nut 81 threadably engaged with the bolt 47. A wall portion 82 (a covering portion) is formed at the flange portion 73. The wall portion 82 is formed by bending an upper end of the flange portion 73 as viewed in FIG. 2 (an end of the flange portion 73 on a spaced-apart side from the housing 66) toward the spaced-apart side from the cylinder 3 (the right side in FIG. 2, and the upper side in FIG. 3). The wall portion 82 has a predetermined height (a dimension in the left-right direction in FIG. 2, i.e., a dimension in a direction extending in parallel with the housing 66) and a predetermined width (a dimension in a vertical direction in FIG. 4, i.e., a dimension in a direction extending in parallel with the cylinder 3) so as to be able to cover a head of the bolt 47.

A foreign object discharge hole 83 (refer to FIG. 4), which is generally circularly opened, is formed through the cover 70 at a position that is located on a lowermost side when the shock absorber 1 is in the mounted state. The foreign object discharge hole 83 is formed by cutting away a part of the cover 70 along a plane P (a cutting plane P) that coincide with an upper surface of a curbstone 84 when the cover 70 illustrated in FIG. 5 maximally approaches the upper surface of the curbstone 84 (a concrete boundary block). In many cases, the curbstone 84 is generally 15 cm to 25 cm in height, and the plane P may be set to a plane having the same height as that. A size (a diameter) of the foreign object discharge hole 83 is similar to or larger than a size of a space between the outlet port 75 and the harness 36. In other words, the cover 70 is configured to be able to discharge a largest foreign object among foreign objects capable of entering the cover 70 via the space between the outlet port 75 and the harness 36, out of the cover 70 via the foreign object discharge hole 83.

Further, the size of the foreign object discharge hole 83 is larger than a space between the cover 70 and the housing 66 or the damping force adjustment mechanism 33. In other words, the cover 70 is configured to be able to discharge a largest foreign object among foreign objects capable of passing through the space between the cover 70 and the housing 66 or the damping force adjustment mechanism 33, out of the cover 70 via the foreign object discharge hole 83. This means that the cover 70 is configured to be able to discharge all of the foreign objects in the cover 70 that has reached the position that is located on the lowermost side when the shock absorber 1 is in the mounted state, out of the cover 70. Strictly speaking, the foreign object discharge hole 83 does not have to be located on the plane P that coincides with the upper surface of the curbstone 84 when the cover 70 maximally approaches the curbstone 84, and only has to be formed so as to be able to prevent the cover 70 from interfering with the curbstone 84.

Next, an operation of the shock absorber 1 according to the present embodiment will be described.

The shock absorber 1 corresponds to a part of a semi-active suspension apparatus of the vehicle, and is vertically mounted between two members, a vehicle body-side member and the vehicle wheel-side member of the vehicle. More specifically, the shock absorber 1 is mounted in such a manner that a distal end of the piston rod 8 on the opposite end side, and the mounting eye 5 are connected to the vehicle body-side member and the vehicle wheel-side member of the vehicle, respectively. The shock absorber 1 is configured to correspond to the right rear wheel of the vehicle, and is mounted on the vehicle in such a manner that the housing 66 (the damping force adjustment mechanism 33) protrudes in a direction of ten o'clock as a clock position with respect to a front direction of the vehicle, but the present invention is not limited to this configuration.

During extension or compression of the piston rod 8 of the shock absorber 1 while the vehicle is running, the damping force adjustment mechanism 33 controls a flow rate of the oil flowing from the annular flow passage 29 to the reservoir 6 by the damping force adjustment valve 34 (the damping force generation unit), thereby generating a damping force. Further, the damping force adjustment mechanism 33 adjusts a valve-opening pressure of the damping force adjustment valve 34 by the solenoid 35, thereby adjusting the damping force to be generated variably (in a stepwise manner or a non-stepwise manner).

The shock absorber 1 mounted on the right rear wheel side of the vehicle in the above-described manner is subject to the stone flying from a B direction in FIG. 2 (a front side in FIG. 5), which has been laid on the road and kicked up by the right rear wheel (hereinafter referred to as the “flying stone”) while the vehicle is running. Then, the present embodiment can protect the damping force adjustment mechanism 33 contained in the housing 66 from the flying stone by the cover 70 at least partially covering the housing 66. Further, in the present embodiment, the cover 70 is made of metal, which can improve strength of the cover 70, and thus a performance for protecting the damping force adjustment mechanism 33 compared to a cover made of plastic.

According to the present embodiment, the foreign object discharge hole 83 is provided at the position that is located on the lowermost side of the cover 70 when the shock absorber 1 is in the mounted state, which allows the foreign object (including rainwater) in the cover 70 to be discharged out of the cover 70 via the foreign object discharge hole 83. As a result, the present embodiment can prevent a failure in the damping force adjustment mechanism 33 that otherwise might be caused by closure of the foreign object discharge hole 83 by the foreign object such as a stone, or immersion of the connector 37 in the rainwater pooled in the cover 70, and thus prevent a failure in the shock absorber 1.

Further, the foreign object discharge hole 83 is formed at the cover 70 by cutting away the part of the cover 70 along the plane P that coincides with the upper surface of the curbstone 84 when the cover 70 maximally approaches the upper surface of the curbstone 84 with the shock absorber 1 in the mounted state. In other words, the foreign object discharge hole 83 is formed in such a manner that a plane containing a contour or profile of the foreign object discharge hole 83 (a contour on an outer peripheral portion of the cover 70) matches the plane P that coincides with the upper surface of the curbstone 84 when the cover 70 maximally approaches the upper surface of the curbstone 84 with the shock absorber 1 in the mounted state, which can prevent the cover 70 and the curbstone 84 from interfering with each other. As a result, the present embodiment can facilitate a layout of the cover 70 and enhance flexibility of a suspension design. In other words, in a case where the foreign object discharge hole 83 is not provided at the cover 70, the cover 70 has a portion that is located at a lowermost position when the shock absorber 1 is mounted on the vehicle body. Cutting away this portion of the cover 70 that is located at the lowermost position converts this portion into the foreign object discharge hole 83. The lowermost position of the cover 70 is heightened by an amount corresponding to the removal of the portion of the cover 70 that is located at the lowermost position, which can increase a possibility of preventing the cover 70 from interfering with an obstacle on a road surface side.

In this manner, the foreign object discharge hole 83 has both a function of discharging the foreign object and a function of preventing the interference with the curbstone 84. Therefore, a process of manufacturing the cover 70 can be streamlined and cost required to manufacture the cover 70 and thus the shock absorber 1 can be reduced, compared to the cover 70 subjected to processing for discharging the foreign object and processing for preventing the interference with the curbstone 84 separately. Further, the strength of the cover 70 can be prevented from being weaken, which otherwise might be caused by an increase in the number of kinds of processing. The curbstone has been described as the member interfering with the cover 70 by way of example, but this member includes a parking block and the like as the obstacle on the road surface side.

Further, in the present embodiment, the size (the diameter) of the foreign object discharge hole 83 is set to be similar to or larger than the size of the space between the outlet port 75 and the harness 36. Further, the size (the diameter) of the foreign object discharge hole 83 is set to be larger than the space between the cover 70 and the housing 66 or the damping force generation mechanism 33, which can ensure that the foreign object introduced into the cover 70 is discharged out of the cover 70 via the foreign object discharge hole 83. As a result, the present embodiment can prevent an abnormal noise and a damage of the damping force generation mechanism 33 that otherwise might be caused by the foreign object remaining in the cover 70, and a failure and the like that otherwise might be caused by the closure of the foreign object discharge hole 83 by the foreign object.

Further, the present embodiment is configured in such a manner that the folded-back portion 76 is formed at the outlet port 75 of the cover 70 by folding back the part of the circumferential edge (the opening portion 71) outwardly from the cover 70, and the harness 36 extending from the connector 37 is brought into contact with the R portion 76A of the folded-back portion 76 of the cover 70. Therefore, the present embodiment can prevent a damage of the harness 36 that otherwise might be caused by contact of the harness 36 with an end (an edge) of the outlet port 75.

Further, the present embodiment is configured in such a manner that the head of the bolt 47 is covered with the wall portion 82 (the covering portion) formed at the flange portion 73 of the cover 70. Therefore, the present embodiment can prevent the bolt 47 from being loosened, which otherwise might be caused by a hit of the frying stone.

The present invention can be configured in the following manner.

In the above-described embodiment, the foreign object discharge hole 83 of the cover 70 is formed as the generally circular hole, but the foreign object discharge hole 83 is not limited to the generally circular hole. For example, the foreign object discharge hole 83 may be a slit, i.e., a slit-shaped foreign object discharge hole 83 formed by cutting away a part of the cover 70 along the plate P that coincides with the upper surface of the curbstone 84 when the cover 70 maximally approaches the upper surface of the curbstone 84 with the shock absorber 1 in the mounted state.

Further, in the above-described embodiment, the cover 70 includes the outlet port 75 for taking out the harness 36 extending from the solenoid 35. However, the member to be taken out from the outlet port. 75, i.e., the member extending from the solenoid 35 outwardly (outwardly from the cover 70) is not limited to the harness 36, and may be, for example, a signal cable or a part of the connector 37.

Further, in the above-described embodiment, the first housing 67 and the second housing 68 are fastened to each other by the lock nut 69, thereby forming the housing 66. However, the first housing 67 and the second housing 68 can be joined to each other by swaging or crimping, thereby forming the housing 66.

Although only some exemplary embodiments of this invention have been described in detail above, those skilled in the art will readily appreciate that many modifications are possible in the exemplary embodiments without materially departing from the novel teaching and advantages of this invention. Accordingly, all such modifications are intended to be included within the scope of this invention.

The present application claims priority under 35 U.S.C. section 119 to Japanese Patent Application No. 2014-143594 filed on Jul. 11, 2014.

The entire disclosure of Japanese Patent Application No. 2014-143594 filed on Jul. 11, 2014 including specification, claims, drawings and summary are incorporated herein by reference in its entirety.

What is claimed is:

1. A damping force adjustable shock absorber configured to be mounted between relatively movable two members, the damping force adjustable shock absorber comprising:
a cylinder sealingly containing hydraulic fluid;
a piston disposed in the cylinder;
a piston rod coupled to the piston and extending out of the cylinder;
a damping force adjustment mechanism disposed in a housing that protrudes from a side of the cylinder; and
a cover that at least partially covers an outer peripheral portion of the housing,
wherein the damping force adjustment mechanism includes a solenoid, and a harness for supplying power to the solenoid from outside, and
wherein the cover includes an outlet port for taking out the harness, and a foreign object discharge hole provided at a position that is located on a lower side when the shock absorber is in a mounted state, and a size of the foreign object discharge hole is substantially the same as or larger than a size of a space between the outlet port and the harness.

2. The shock absorber according to claim 1, wherein the provision of the foreign object discharge hole to the cover heightens a lowermost position of the cover with the shock absorber mounted on a vehicle body.

3. The shock absorber according to claim 1, wherein the cover has a bottomed cylindrical shape having an opening portion and a bottom portion, and a folded-back portion is formed at the outlet port by folding back the opening portion outwardly.

4. The shock absorber according to claim 2, wherein the cover has a bottomed cylindrical shape having an opening portion and a bottom portion, and a folded-back portion is formed at the outlet port by folding back the opening portion outwardly.

5. The shock absorber according to claim 3, wherein a flange portion is integrally provided at the opening portion of the cover,
wherein the flange portion is configured to be fastened to an attachment member provided at the cylinder by a fastening member, and
wherein the flange portion includes a covering portion at an end of the flange portion, the covering portion being configured to partially cover the fastening member.

6. The shock absorber according to claim 4, wherein a flange portion is integrally provided at the opening portion of the cover,
wherein the flange portion is configured to be fastened to an attachment member provided at the cylinder by a fastening member, and
wherein the flange portion includes a covering portion at an end of the flange portion, the covering portion being configured to partially cover the fastening member.

7. A damping force adjustable shock absorber configured to be mounted between relatively movable two members, the damping force adjustable shock absorber comprising:
a cylinder sealingly containing hydraulic fluid;
a piston disposed in the cylinder;
a piston rod coupled to the piston and extending out of the cylinder;
a damping force adjustment mechanism disposed in a housing protruding from a side of the cylinder; and
a cover that at least partially covers an outer peripheral portion of the housing,
wherein the damping force adjustment mechanism includes a solenoid, and an extension member extending from the solenoid outwardly, and
wherein the cover includes an outlet port for taking out the extension member, and a foreign object discharge hole provided at a position that is located on a lower side when the shock absorber is in a mounted state, and a size of the foreign object discharge hole is substantially the same as or larger than a size of a space between the outlet port and the extension member.

8. A protection member for protecting a damping force adjustable shock absorber including a damping force adjustment mechanism that protrudes in a direction intersecting with a longitudinal direction of the damping force adjustable shock absorber, the protection member comprising:
a cover that at least partially covers an outer peripheral portion of the damping force adjustment mechanism;
the cover including an outlet port for taking out an extension member extending from the damping force adjustment mechanism outwardly, and a foreign object discharge hole provided at a position that is located on a one-end side of the damping force adjustable shock absorber when the protection member is mounted on the damping force adjustable shock absorber,
wherein a size of the foreign object discharge hole is substantially the same as or larger than a size of a space between the outlet port and the extension member.
